(19) United States
(12) Patent Application Publication
(10) Pub. No.: US 2014/0142939 A1
(43) Pub. Date: May 22, 2014

(54) METHOD AND SYSTEM FOR VOICE TO TEXT REPORTING FOR MEDICAL IMAGE SOFTWARE

(71) Applicant: Algotes Systems Ltd., Rochester, NY (US)

(72) Inventors: Yinon Aradi, Ra'anana (IL); Yonatan Dorman, Ra'anana (IL); Yosef Y. Markov, Ra'anana (IL); Uri U. Einav, Yuvalim (IL); Hadas H. Padan, Ra'anana (IL)

(21) Appl. No.: 14/084,649

(22) Filed: Nov. 20, 2013

Related U.S. Application Data
(60) Provisional application No. 61/728,993, filed on Nov. 21, 2012.

(51) Int. Cl. G10L 15/26

(52) U.S. Cl. CPC G10L 15/265
USPC 704/235

(57) ABSTRACT

A system and method for voice to text reporting for medical image software. The system and method may optionally include a separate voice to text engine, for converting the voice report to text, and also some type of medical image software, for providing medical image processing capabilities. According to at least some embodiments, both capabilities are provided remotely to the user's computer, and may optionally be provided through a “zero footprint” on the user's computer.

### CROSS REFERENCE TO RELATED APPLICATIONS

This application claims the benefit of U.S. Provisional application U.S. Ser. No. 61/728,993, provisionally filed on 21 Nov. 2012, entitled “METHOD AND SYSTEM FOR VOICE TO TEXT REPORTING FOR MEDICAL IMAGE SOFTWARE”, in the names of Aradi et al, which is incorporated herein by reference in its entirety.

### FIELD OF THE INVENTION

The invention relates to a system and method for voice to text reporting for medical image software and particularly, but not exclusively, to incorporating such reporting as part of the medical image review process.

### BACKGROUND OF THE INVENTION

Medical image software has become a diagnostic tool. Such software allows skilled medical personnel, such as doctors, to view, manipulate and interact with medical images such as CT (computerized tomography) scans, MRI (magnetic resonance imaging) scans, PET (positron emission tomography) scans, mammography scans and the like. As the amount of information that radiologists are forced to handle increases, so is the time spent on each study. In addition, the number of studies a radiologist needs to review is increasing as well. This can cause a bottleneck in interpreting and reporting studies for further follow-up by the referring physicians. Therefore, radiologists desire to accurately and rapidly interact with medical image processing software and ultimately, to be able to report and share their results in as short and efficient a time as possible so as to speed up patient care.

Part of the medical image diagnostic process involves the radiologist's report. Current reporting software varies between voice recognition systems to reports being dictated into a dictation device for later typing by a skilled typist, to reports being typed by the radiologist (or doctor or other trained personnel) or dictated by telephone to medical personnel. A common feature of the above methods is that all of them take place while the radiologist or other trained personnel is viewing dedicated reporting software. This software is installed on a radiology reporting station, either in parallel to the review software (such as a PACS [Picture Archiving And Communication System] viewer or dedicated workstation) or integrated into the PACS viewer itself such as in native reporting on Carestream's Vue PACS.

Dictation type methods may lead to errors, as non-medical personnel may not understand the words being dictated; furthermore, even the more automatic reporting modules incorporating voice recognition type software are tied down to the reviewing software being run on a desktop machine located in the hospital/facility or in some cases the home office of the radiologist. This necessitates a situation in which the radiologist logs on to the hospital network from a desktop computer so as to review/create the report, a situation which may be time consuming and could adversely affect patient care.

The above issues could be magnified in an emergency situation wherein the radiologist needs to quickly review the images and report them. Often times, these emergency situations occur at night when the on-call radiologist is not in the hospital. In that situation, the radiologist usually receives a phone call from the emergency response (ER) team requesting the radiologist to review images, in which case the radiologist needs to log into the hospital network from the radiologist's home computer, review the images and then dictate/relay a report over the phone. This method can be error prone and take crucial time during an emergency procedure.

The situation becomes complicated when more than one radiologist/doctor reviews and/or adds to a medical image diagnostic report before it is considered to be finalized, for example when a resident's report needs to be reviewed by a more senior doctor, or when a second opinion is requested, the results of which are then to be incorporated into a final report. The different doctors in this situation may not be physically present at the same location, further complicating the need for combining their input into a single final report.

US2008/0235014 to Oz describes a general system for medical dictation.

US2010/0114598 to Oez describes a medical billing system.

US2012/0173281 to DiLella describes a medical report generation system.

### SUMMARY OF THE INVENTION

There is therefore a need for a medical image review system that includes integrated speech to text conversion so that medical personnel can dictate a diagnosis report thereby preventing the potential for errors outlined above and also speeding up the report generation process. It is desirable for the system to store medical images along with their associated reports such that these are accessible from multiple locations and using multiple methods, optionally including a “zero-footprint” method such as Web browser. Still further, it is desirable for the system to include mechanisms that allow for multiple stages of review and approval by different medical personnel in different locations accessing the system using different methods.

The present invention, in at least some embodiments, provides a system and method for voice to text reporting for medical image software over a computer network, such as the Internet. Such a system and method may optionally feature a separate voice to text engine, for converting the voice report to text, and some type of medical image software, for providing medical image processing capabilities.

According to at least some embodiments, capabilities are provided remotely to the user's computer, and may optionally be provided through a “zero footprint” application running from an internet or web browser on the user's computer (software for displaying mark-up language documents, for example according to HTML).

According to at least some further embodiments, the system provides for storage of the converted text report along with the medical images as well as allowing multiple stages of review and approval by different medical personnel in different locations accessing the system using different methods.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIGS. 1A and 1B show exemplary, illustrative systems according to at least some embodiments of the present invention for voice to text reporting for medical image software.

FIGS. 2A and 2B show exemplary, illustrative processes according to at least some embodiments of the present invention for voice to text reporting for medical image software.

FIG. 3 shows an exemplary, illustrative process for the operation of the systems of FIGS. 1A and 1B according to at least some embodiments of the present invention.

FIG. 4 shows an exemplary, illustrative method according to at least some embodiments of the present invention for documenting an informal workflow.

FIGS. 5A and 5B show exemplary, illustrative screenshots according to at least some embodiments of the present invention.

### DESCRIPTION OF EMBODIMENT OF THE INVENTION

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a tablet, a PDA (personal digital assistant), or a pager. Any two or more of such devices in communication with each other may optionally comprise a “computer network”.

Although the present description centers around medical image data, it is understood that the present invention may optionally be applied to any suitable three dimensional image data, including but not limited to computer games, graphics, artificial vision, computer animation, biological modeling (including without limitation tumor modeling) and the like.

At least some embodiments of the present invention are now described with regard to the following illustrations and accompanying description, which are not intended to be limiting in any way.

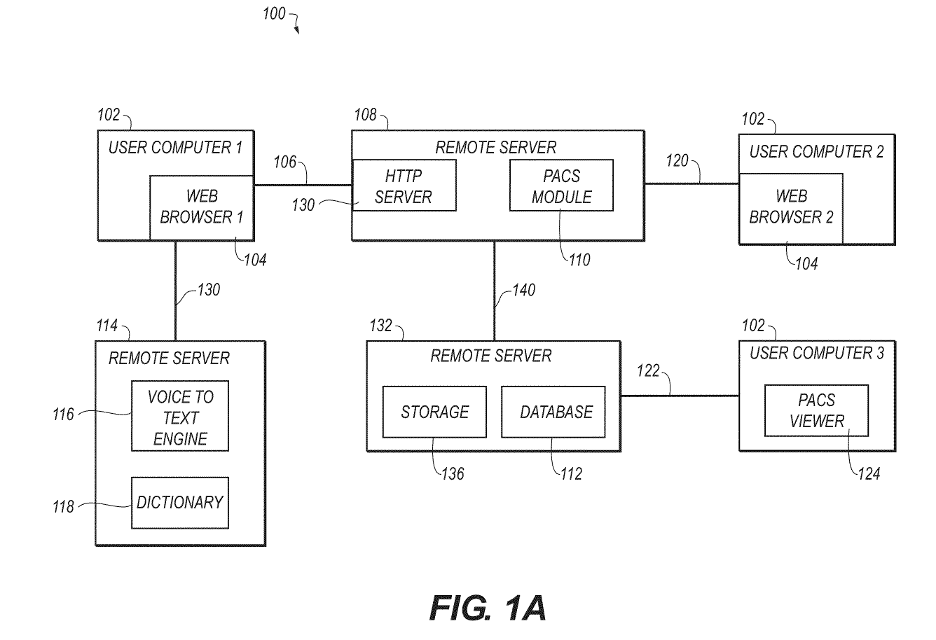

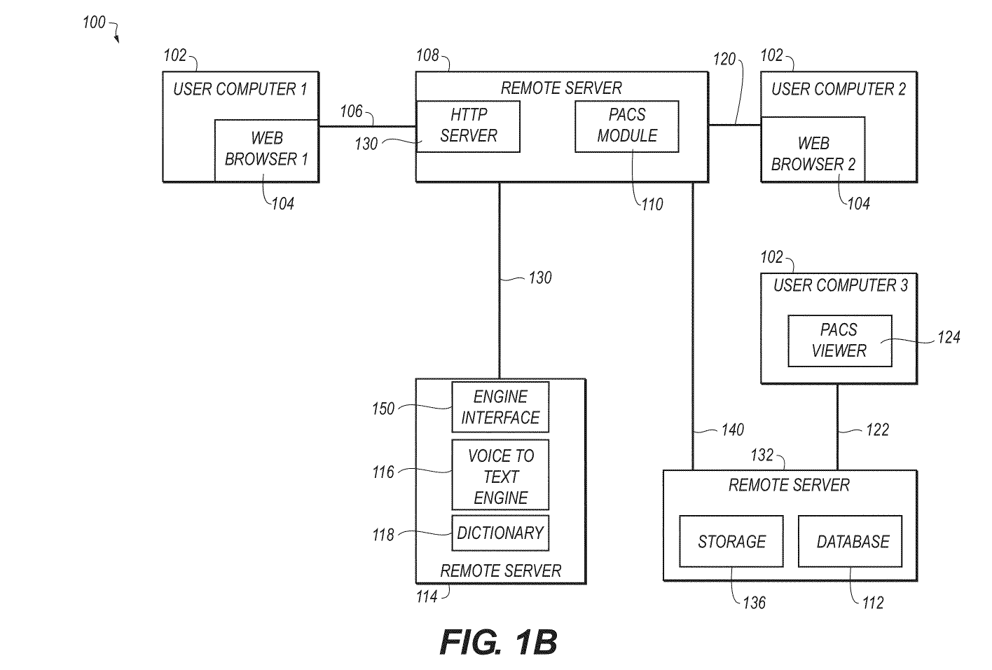

FIG. 1A shows an exemplary, illustrative system according to at least some embodiments of the present invention for voice to text reporting for medical image software. As shown, a system 100 features a plurality of user computers 102 (shown as user computers 1-3 102 for the sake of illustration only and without any intention of being limiting), two of which are shown as operating a web browser 104, again for the sake of illustration only and without any intention of being limiting. Web browser 104 is a non-limiting example of a software program, capable of communicating according to HTTP and rendering HTML (HyperText Markup Language); any suitable software program or “app” could be used in its place, for example if user computer 102 were to be implemented as a “smartphone” or cellular telephone with computational abilities.

User computer 1 102 is in communication with a remote server 108 through a computer network 106. Computer network 106 may optionally be any type of computer network, such as the Internet for example. For the sake of security, computer network 106 preferably features at least a security overlay, such as a form of HTTPS (secure HTTP) communication protocol, or any type of security overlay to the communication protocol, such as 256-bit SSL3 AES and security certificates for example, and may also optionally feature a VPN (virtual private network) in which a secure “tunnel” is effectively opened between user computer 102 and remote server 108.

It should be noted that remote server 108 may optionally comprise a plurality of processors and/or a plurality of computers and/or a plurality of virtual machines, as is known in the art.

Remote server 108 optionally and preferably operates an HTML server 130 as well as a medical image processing software, shown herein as PACS module 110, although any suitable medical image processing software may optionally be provided, for example which operates according to DICOM (Digital Imaging and Communications in Medicine). PACS module 110 may optionally comprise any type of medical image processing software or a combination of such softwares. PACS module 110 is preferably in communication with a remote server 132 which may be a PACS server or a DICOM archive. Remote server 132 stores the medical images in storage 136 and also comprises a database 112 for holding medical image data.

Database 112 is shown herein as being incorporated into remote server 132 but may optionally be incorporated into remote server 108 or may be separate from these servers (not shown). Remote server 108 communicates with remote server 132 through a computer network 140, which may optionally be implemented as described with regard to computer network 106, optionally and preferably including the same or similar security features.

PACS module 110 processes medical image data, for example allowing images to be segmented or otherwise analyzed; supporting “zoom in-zoom out” for different magnifications or close-up views of the images; cropping, highlighting and so forth of the images. HTTP server 130 operating on server 108 preferably renders the Web interface of the PACS module 110 in HTML so that Web browser 104 can display a PACS interface through which the user can perform such actions and view results using user computer 102. Optionally the actions are performed locally at user computer 102 but are preferably performed at remote server 108.

Optionally and more preferably, PACS module 110 provides complete support for medical image processing, such that the medical image processing software has “zero footprint” on user computer 102 or on web browser 104, such that optionally and more preferably not even a “plug-in” or other addition to web browser 104 is required. In other words, web browser 104 does not feature a process associated plugin, meaning a plugin that is associated with or operated by the medical image processing software. Such complete support for remote medical image viewing and analysis is known in the art, and is in fact provided by the Vue Motion product currently being offered as part of Carestream Health offerings. All of these examples relate to examples of “thin clients”, with low or “zero” footprints on user computer 102, preferably provided through a web browser but optionally provided through other software.

However, currently medical image processing software, while providing support for such remote medical image viewing and analysis, does not provide support for voice to text report generation, nor does it provide support for combining such generated reports with the medical images that were viewed by the doctor while generating the report. System 100 overcomes these drawbacks of the background art by also providing a remote server 114, which operates a voice to text engine 116. Voice to text engine 116 may optionally be any such engine which is known in the art, including but not limited to such engines that are available from Nuance (for example and without limitation, the 360 SpeechAnywhere platform). Voice to text engine 116 may also optionally feature a dictionary 118 as shown, which may optionally and preferably comprise specialized medical terms, of the type that are likely to be of interest or needed for dictating a medical image diagnostic report. Remote server 114 communicates with user computer through a computer network 130, which again may optionally be implemented as described with regard to computer network 106, optionally and preferably including the same or similar security features.

The user preferably interacts with voice to text engine 116 as follows. The user, such as a doctor for example, reviews medical images through web browser 1 104, being operated by user computer 1 102, in communication with remote server 108. As the user reviews these medical images, the user dictates a report through a microphone or other voice collecting device on user computer 1 102 (not shown). The voice data is then transmitted from user computer 1 102 to remote server 114, for processing by voice to text engine 116. Voice to text engine 116 then transmits back a text report to the user. The converted text is preferably transmitted back for viewing as the user dictates or is at least transmitted back intermittently, such that the user views dictated text in near real time. Alternatively, the text is transmitted back when the user completes their dictation. Optionally and preferably, voice to text engine 116 transmits a list of words matching the dictation, while the actual generation of the report (and hence preferably also editing of the report) is performed through web browser 104.

In addition to being viewed, the text may be optionally edited through web browser 1 104 for example (acting as a zero footprint PACS user interface), or alternatively through any type of word processing software (not shown); for example, voice to text engine 116 may optionally use a secure channel to transmit back the written report. The user may then optionally change the report manually, by typing on the computer keyboard of user computer 1 102 (not shown) for example, before the report is transmitted to database 112.

As an additional security measure, optionally neither the voice data nor the resultant text data is stored on remote server 114; in other words, optionally a session is set up to connect user computer 1 102 and remote server 114 as necessary for creating the text report, with data being maintained only in a temporary memory on remote server 114 and not in a permanent database. Once the session has been closed, for example once the user is finished with at least the dictation part of the report generation process, then any temporarily stored data on remote server 114 is preferably flushed and is not stored permanently. However, dictionary 118 may optionally be an exception to this rule, as dictionary 118 may optionally learn from a particular user or from a plurality of users, and incorporate corrections or changes made by the user on a permanent basis.

With regard to the communication between user computer 1 102 and remote server 114, optionally the “zero footprint” standard is maintained, such that all support for such communication effectively occurs through web browser 1 104. Otherwise, some type of user interface software would need to be present on user computer 1 102, for supporting communication with voice to text engine 116 (not shown). The user interface enabling control of the dictation and voice to text process on Web browser 1 104, is provided by remote server 108.

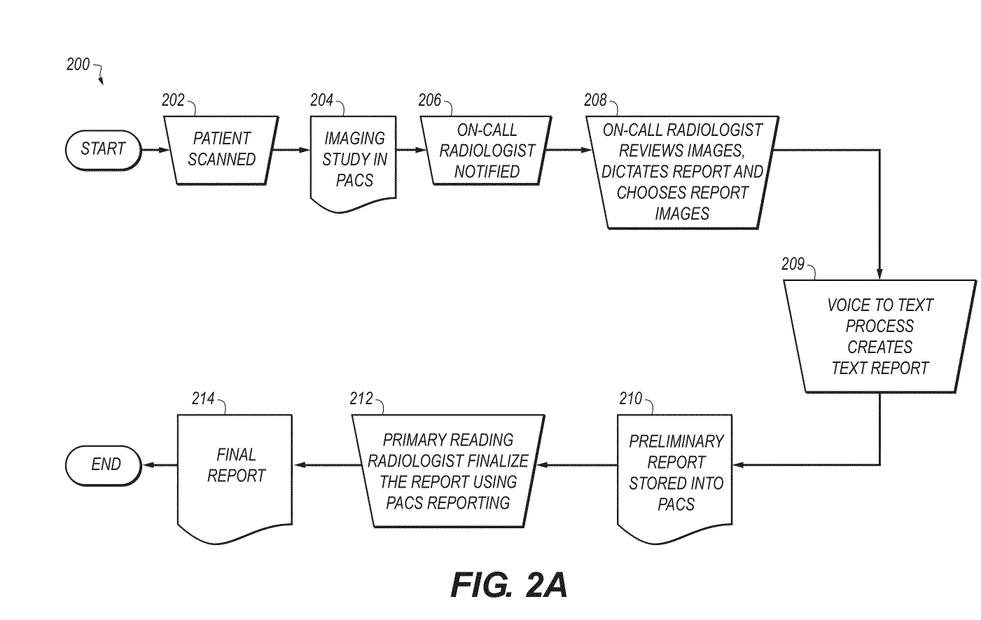

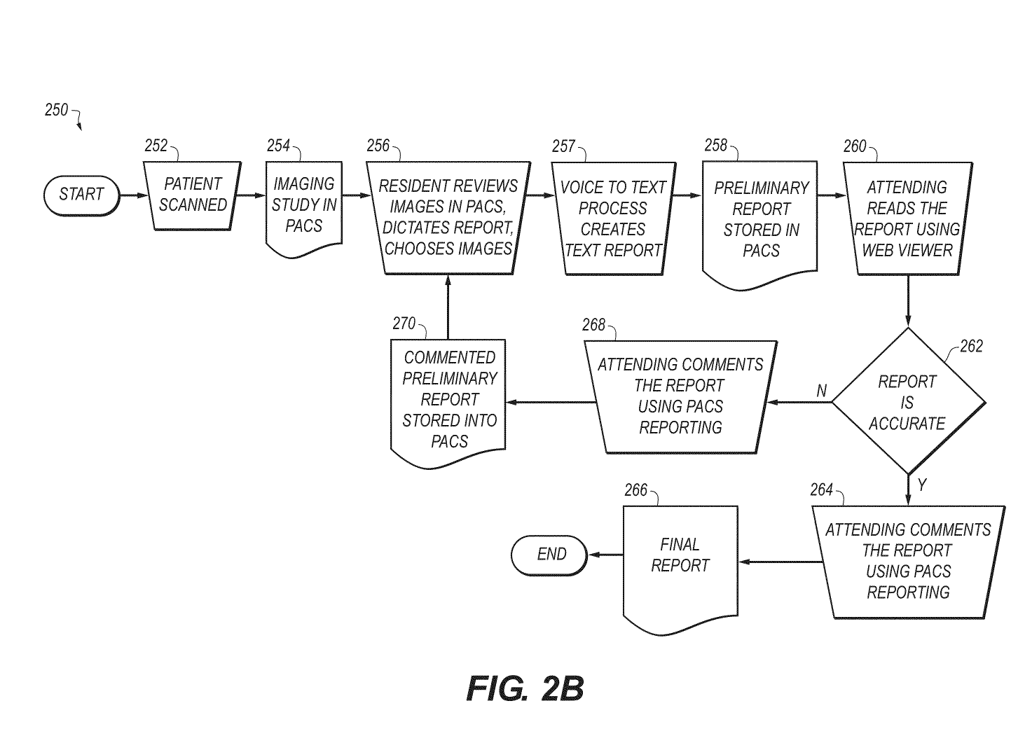

The operation of system 100 is described in greater detail with regard to FIGS. 2A and 2B, but briefly system 100 may optionally operate as follows. The user views medical images through web browser 1 104, supported by PACS module 110. As the user views these images, the user verbally dictates a report, which may optionally be transmitted simultaneously or only after dictation is completed to remote server 114. As the user dictates the report, or optionally after dictation is complete, the user may optionally select one or more medical images for being combined with the report through web browser 1 104. For example, the user may optionally request that a particular image be included through “bookmarking” the image through an interaction with web browser 1 104; the user may also optionally request that the entire image be included or only a link to the image (for example, to reduce the size of the final report). Optionally, any image that the user views while recording the dictated report may be automatically included; alternatively or additionally, some combination of these features may optionally be used to somehow connect, combine, bundle or link one or more images with the report. It is also possible to include all images in the final report.

As described above, the Voice to text engine 116 then transmits back a text report to the user, for being viewed and optionally edited through web browser 1 104 for example (acting as a zero footprint PACS user interface), or alternatively through any type of word processing software (not shown). The user may then optionally change the report manually, by typing on the computer keyboard of user computer 1 102 (not shown) for example.

Once the user is satisfied that the text is correct and the appropriate images have been included and the report is therefore complete, the user optionally and preferably “signs off” or otherwise indicates the report's completed state through web browser 1 104. This information is then transmitted to remote server 108, which optionally and preferably stores a copy of the report in database 112 and/or in a separate DICOM archive such as in storage 136 as previously described, more preferably along with an indication of the report's connection to various images. Optionally the report may be stored in a Radiology Information System or in a Hospital Information System.

Optionally, an additional user may request to view the report through user computer 2 102, operating web browser 2 104. Alternatively, in fact the same user may request to view the report but through a different computer. User computer 2 102 is preferably in communication with remote server 108 through a computer network 120, which may optionally be implemented as described previously for computer network 106. Web browser 2 104 enables the user to retrieve the report from remote server 108 (for example from database 112) and to make any edits or changes, or comments; the user may then optionally sign off on the report or may alternatively pass the report to another user for signing off. Optionally and preferably, all such communication regarding the report passes through remote server 108 for security purposes; furthermore, by passing through remote server 108, optionally and preferably the images themselves do not need to be sent as part of the report (although they can be).

Although the previous description centered around user computers 102 which supported “zero footprint” interactions with remote server 108 through web browsers 104, in fact optionally a user computer 3 102 may feature a PACS viewer 124 as shown. PACS viewer 124 features some or all of the functionality of PACS module 110 for image processing, analysis and manipulation. The user operating user computer 3 102 may therefore optionally change one or more of the images through local processing by PACS viewer 124 on user computer 3 102 as shown. PACS viewer 124 may also optionally feature its own image database (not shown). User computer 3 102 is preferably in communication with remote server 132 through a computer network 122, which may optionally be implemented as described previously for computer network 106.

Each of user computer 2 102 and user computer 3 102 may optionally be in contact (not shown) with remote server 114 in order to be able to interact directly with voice to text engine 116.

It should be noted that although computer networks 106, 120, 122, 130 and 140 are described as being separate networks, in fact any plurality of such networks, or even all such networks, may optionally be comprised in a single network.

FIG. 1B shows another exemplary, illustrative system according to at least some embodiments of the present invention for voice to text reporting for medical image software. The operation of this embodiment of system 100 is similar to that of FIG. 1A, except that access to voice to text engine 116 is provided through remote server 108, whether operated (not shown) by remote server 108 or operated by remote server 114 which communicates with all user computers 102 through remote server 108 as shown. In this embodiment, remote server 114 features an engine interface 150, which supports interactions between remote server 108 and voice to text engine 116. The “zero footprint” can still be maintained at user computers 102, as instead the voice to text support functionality is shifted to remote server 108 and/or remote server 114.

FIGS. 2A and 2B show exemplary, illustrative processes according to at least some embodiments of the present invention for voice to text reporting for medical image software.

FIG. 2A, as shown, relates to an exemplary process for an emergency situation, for supporting the generation of a written medical image diagnostic report. A process 200 starts with a patient being scanned on an emergency basis in stage 202; the medical images are then uploaded to some type of PACS-enabled server in stage 204. In stage 206, the radiologist (or other doctor) that is on-call is asked to provide a diagnostic analysis of the medical image data. It should be noted that the doctor may optionally be located remotely from the PACS-enabled server and may not in fact even have access to a computer with a local PACS module, but may instead perform the below stages through a remote computer, tablet or smartphone, for example optionally through the above described zero footprint implementation.

In stage 208, the doctor reviews the medical images and dictates the report (for example by using the system as described above with reference to FIGS. 1A and 1B).

After dictation is complete, the doctor may optionally select one or more medical images for being combined with the report. For example, the doctor may optionally request that a particular image be included through “bookmarking” the image; the doctor may also optionally request that the entire image be included or only a link to the image (for example, to reduce the size of the final report). Optionally, any image that the doctor views while recording the dictated report may be automatically included; alternatively or additionally, some combination of these features may optionally be used to somehow connect, combine, bundle or link one or more images with the report. It is also possible to include all images in the final report.

In stage 209 the dictated report is converted to text using the voice to text process including review, correction, and editing by the doctor as described with reference to FIGS. 1A and 1B above. The doctor may then optionally either ‘save as a draft’ or ‘sign’ the report (usually as preliminary). In stage 210, the report which includes both images or links to images and the approved text is then stored through the previously described remote server with PACS module, and is available for another doctor to continue the reporting process, optionally also using the speech or text process, until a final report is available. As shown in this non-limiting example, the process continues with a senior radiologist's review in stage 212, leading to finalization of the report in stage 214.

Among the advantages of this process (but without wishing to enumerate a closed list) are that none of the doctors involved need to be at the same physical location, nor do they need to be in direct communication by telephone, email and so forth. Instead the process 200 permits different doctors to comment and report at different times, and also permits a senior doctor (such as a senior radiologist for example) to control when the report is finalized, and hence to control process 200. The voice to text mechanism described above is an integral part of this process and offers the desired advantages as outlined in the summary of the invention such as speeding up the report generation process while reducing the potential for errors in the dictation process. Additionally, the functions described above are part of an integrated system.

Other safeguards and requirements may also optionally be built into process 200, which are not necessarily automatically available today, such as the requirement for at least one doctor to review the report before it can be signed as final. Furthermore, these advantages are available in an emergency situation, which by its very nature is not planned and so which can strain manually implemented processes.

FIG. 2B shows an exemplary process for supporting the generation of a written medical image diagnostic report by a resident, which is then finalized after review by a more senior physician. A process 250 starts with a patient being scanned on any basis (and not necessarily an emergency basis) in stage 252; the medical images are then uploaded to some type of PACS-enabled server in stage 254. In stage 256, the resident reviews the medical images and generates a preliminary report through dictation (for example as described above). At stage 257, the dictated report is converted into a text based report using the systems as described above. It should be noted that the doctor may optionally be located remotely from the PACS-enabled server and may not in fact even have access to a computer with a local PACS module, but may instead perform the below stages through a remote computer, tablet or smartphone, for example optionally through the above described zero footprint implementation.

In stage 258, the preliminary report is stored in text form along with associated images through the previously described remote server with PACS module. In stage 260, the attending physician is able to review the report, with or without access to a local PACS module as previously described. In stage 262, the attending physician determines whether the report is accurate. If the attending physician decides that the report is generally accurate, then in stage 264, the attending physician makes any comments or changes, optionally using the speech to text capabilities, and signs the report. In stage 266, the final report is made available, again optionally through the above described remote server and PACS enabled system.

However, if the attending physician feels that any/significant changes need to be made to the report, then from stage 262 the process instead continues to stage 268, in which the attending physician requests various changes to the report from the resident, optionally using the speech to text capabilities. In stage 270, the preliminary report is returned for the resident to continue to work on it, and the process continues at stage 258. This cycle may optionally continue until the final report is made available in stage 266.

Again, process 250 has advantages over fully manual processes, in that again (without wishing to be limited by a closed list), the resident and the attending physician do not need to be at the same physical location, nor do they need to be in direct communication by telephone, email and so forth. The process 250 permits different doctors to comment and report at different times, and also permits a senior doctor (such as a senior radiologist for example) to control when the report is finalized, and hence to control process 250. The voice to text system here again offers the advantages outlined above.

Other safeguards and requirements may also optionally be built into process 250, which are not necessarily automatically available today, such as the requirement for at least one doctor to review the report before it can be signed as final. Furthermore, doctors or other users may be present at widely separated locations and indeed may optionally interact through process 250 from any type of location and also through any type of suitable electronic device, optionally including but not limited to mobile or portable electronic devices.

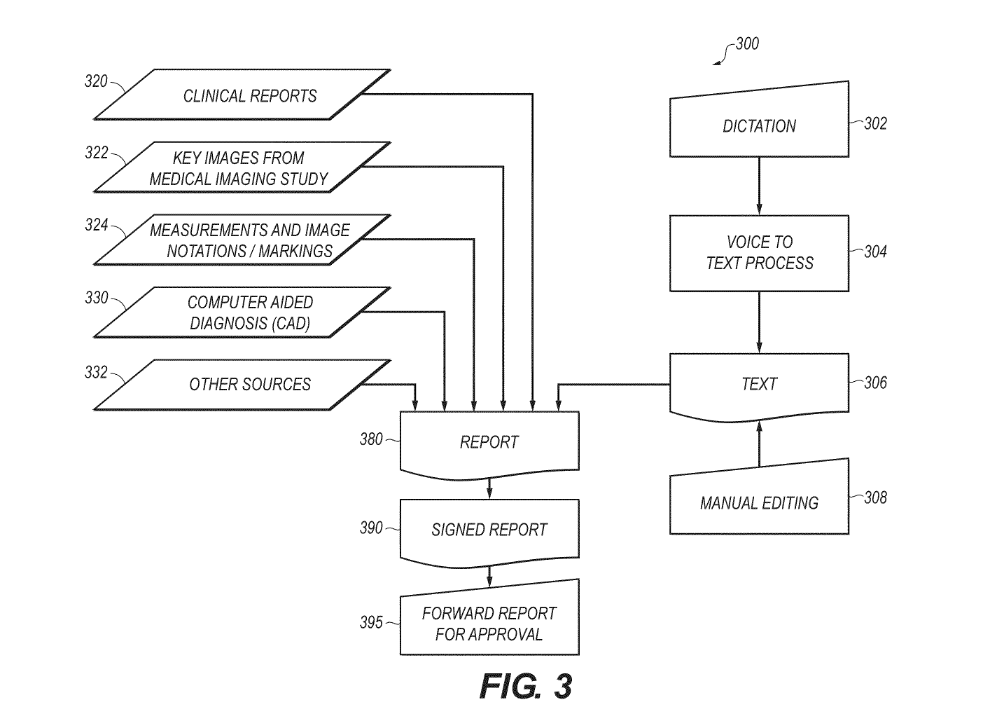

FIG. 3 shows an exemplary, illustrative process 300 for the operation of the systems of FIGS. 1A and 1B according to at least some embodiments of the present invention. FIG. 3 illustrates optional sources and inputs that comprise a report such as those described with reference to the embodiments above.

As shown, one or more different sources may be used to provide information for creating a report 380, which at the end of the process becomes a signed report (at 390) that is stored in the PACS. The sources may include text which is a translation of the dictation of the user, for example as described above and shown in 302-306, text that has been added manually by the user or edited following the voice to text process, as shown at 308, and one or more medical data elements which are received and/or selected by the user. For example: the user may add clinical reports (at 320), such as structured reports generated by modalities (imaging equipment) such as DICOM SR (structured reporting), vessel analysis and calcium scoring reports; select key images from the medical imaging studies (at 322); and/or add measurements and image annotations which are related to her diagnosis, as shown at 324.

Optionally, a medical imaging study or segments of the study in the form of one or more images therefrom (at 322) may be added to the report as decided by the user. Optionally, the segments, which are added to the report, define anatomic sites, each referred to in the dictation or text accompanying these segments. In such a manner, the report may provide a visual reference to the diagnosis of the user. Optionally, the above described PACS viewer and/or web browser provided image viewer allows the user to mark anatomical sites on the segments of the medical imaging study (as at 324) which are added to the report, optionally in the form of bookmarks that can then be inserted into the text such that a user viewing the text can select a bookmark and be shown the marked site on the image. In such a manner, the user may refer the reader to specific areas of interest by pointing out the marked sites.

Optionally, the above described voice to text process, as at 304, may be used for identifying references to anatomical sites defined by the user. In such an embodiment, the user may optionally select segments of the imaging study at 322 according to the identified anatomical sites and add them to the report in association with a respective section in the diagnosis. Alternatively or additionally the user may mark segments of the imagining study as at 324 according to the identified anatomical sites and associate them to respective sections of the report. Optimally, the user may include a key-phrase in his/her voice dictation that will be interpreted by the voice to text process as an instruction to add a link to a defined bookmark in the converted text. The bookmark function is described above.

Optionally, the above described PACS module is connected to a computer aided diagnosis (CAD) system 330. In such an embodiment, the CAD system 330 may receive and process one or more diagnosed medical imaging studies and output an automated analysis accordingly. Optionally, the automated analysis is added to the report, at system 330, and/or used to automatically update of the report.

According to some embodiments of the present invention, the imaging study is presented to the user according to a protocol which has been selected according to the modality and/or the anatomical site which is related thereto. Optionally, the imaging study comprises a set of views, such as posterior, anterior, lateral, superior and/or interior views. In such an embodiment, the views may be presented sequentially. Each presented view allows the user to relate thereto and to determine when to present the following view. Optionally, the views are added in a sequential manner to the report, optionally each with an association to the related diagnosis which has been provided by the user. In such a manner, the report that is outputted in the end of the medical reporting session, for example as shown at signed report 390, may be generated in a manner such that each diagnosis is presented with the view on which it is based. Optionally, the sequence is dynamically adjusted according to the behavior of the user.

As shown at 380, the report is created based on the possible sources combined with the text diagnosis. Optionally, as shown at 390, the report is signed, for instance with a digital signature. Optionally, the signed report is forwarded at forwarding process 395, as previously described with reference to FIGS. 2A and 2B, for comments and/or approval and/or to a report database, such as database 112 of FIGS. 1A and 1B.

The generated report, as produced by process 300 includes rich content such as text, measurements, image notations/markings and bookmarks to these, and images. Optionally, the reports further comprise rich data such as hyperlinks, tables, and graphs which are based on a combination of inputs from the user and/or the received medical imaging studies and/or medical records added at other sources process 332.

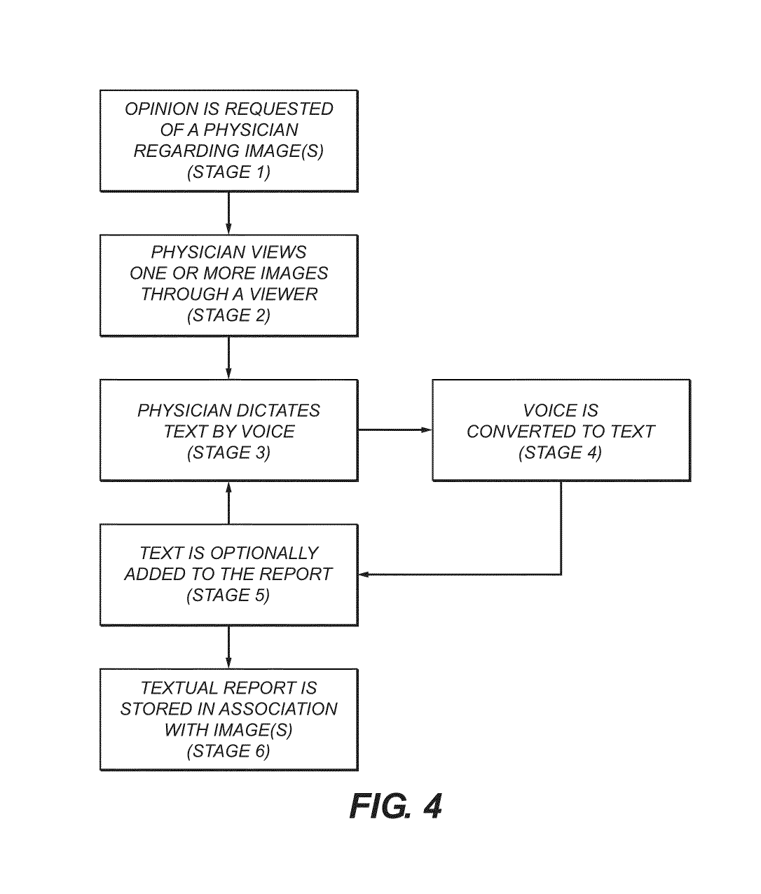

FIG. 4 shows an exemplary, illustrative method according to at least some embodiments of the present invention for documenting an informal workflow. By “informal workflow” it is meant a workflow that does not necessarily end in the production of a diagnostic or medical report, or where the information flow is not documented in any digital system. For instance, in ER scenarios a patient is scanned, the doctor contacts the radiologist by phone to review the images and provide an opinion. The radiologist review the images, provides the opinion but no record of the conversation or the radiologist's opinion is stored anywhere. As shown, in stage 1, an opinion is requested of a physician regarding a medical image study or alternatively a portion of such a study, comprising one or more images. The request may optionally be sent through a computer network, for example by email, or alternatively may optionally be made verbally.

In stage 2, the physician views one or more images, comprising part or all of an image study, according to the request (which may optionally direct the physician to the specific image(s) or study, or alternatively may optionally refer to the patient for example) through a viewing application as described above, whether a PACS viewer or a “thin client” viewer (for example provided through a web browser as described herein). The viewing application may optionally be provided through a computer or cellular telephone (such as a smartphone) or other electronic device as described above.

In stage 3, as the physician views the one or more images, the physician dictates a verbal (i.e.—voice) report to the electronic device, which is preferably the same electronic device that is displaying the one or more images.

In stage 4, the verbal (i.e.—voice) report is converted to text as previously described. In stage 5, text is optionally added to, deleted from, or changed within the report through any suitable mechanism, including but not limited to additional verbal information that is converted to text, manually editing the reporting, manually or automatically adding, deleting, changing or editing text, and so forth.

In stage 6, the verbal report is preferably stored in association with the one or more images, or image study, thereby enabling the opinion and thoughts of the physician to be captured and to be made part of the permanent record regarding the image(s) viewed.

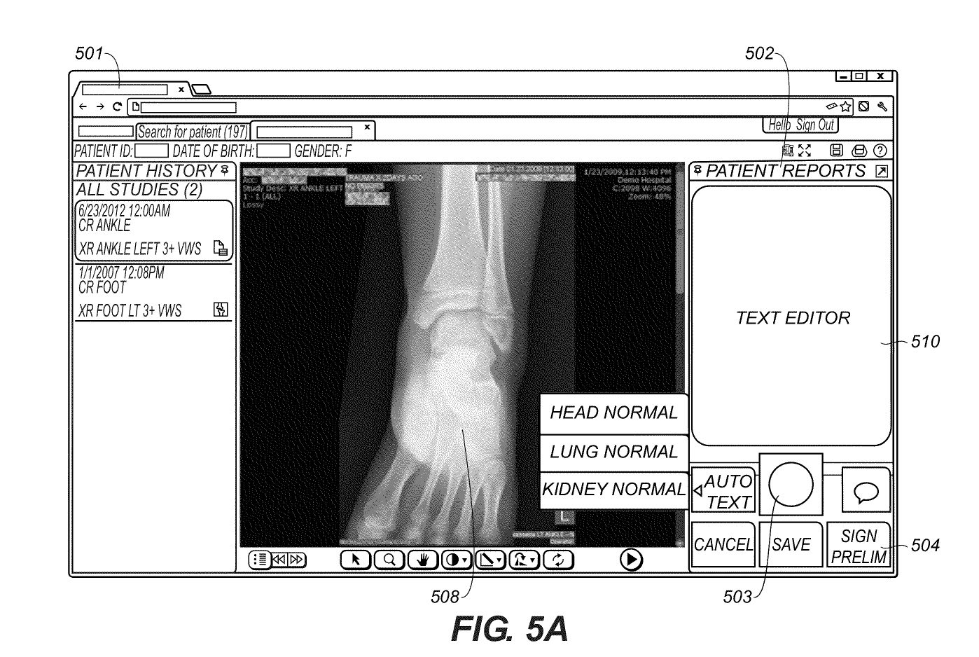

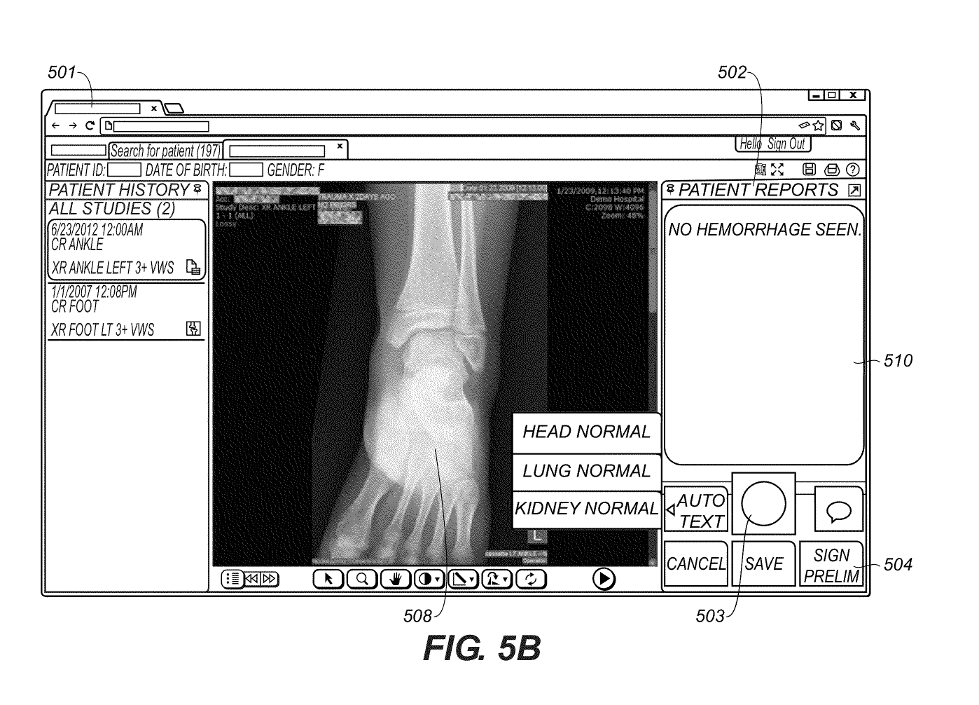

FIGS. 5A and 5B show exemplary, illustrative screenshots according to at least some embodiments of the present invention. The screens show the medical image viewing and reporting application in a Web browser 501. The right pane 502 comprises a Web enabled radiology reporting interface, with various elements required to implement the embodiments described above. These elements include a record button 503 for initiating the voice to text process; a sign button 504 allowing the practitioner to digitally sign the report; and a text editor 510 for adding text or reviewing and editing text that has been converted from voice. As shown, the radiologist would typically manipulate the controls of the radiology reporting functions on the right 502 while viewing a medical image 508 on the left. FIG. 5B shows text editor 510 following conversion of a spoken diagnosis into text.

Although the present description centers around interactions with medical image data, it is understood that the system may be applied to any suitable three dimensional image data, including but not limited to computer games, graphics, artificial vision, computer animation, biological modeling (including without limitation tumor modeling) and the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A process for generating text from dictation by a user, comprising:
displaying one or more medical images through a medical image viewer to the user, the medical image viewer being operated by a thin client;
receiving one or more verbally dictated words by the user;
generating a written report from the verbally dictated words; and
associating the written report with the one or more medical images.

2. The process of claim 1, further comprising providing a remote computer for operating a medical image software and a user computer for operating the thin client; wherein the thin client comprises a web browser.

3. The process of claim 1, further comprising providing a remote computer for operating a medical image software and a user computer for operating the thin client; wherein the thin client comprises a zero footprint software.

4. The process of claim 3, wherein the zero footprint software is a web browser without a process associated plugin.

5. The process of claim 3, wherein the user computer comprises a tablet, a smart phone, a cellular telephone or other portable electronic device.

6. The process of claim 5, wherein the generating the written report is performed by the remote computer.

7. The process of claim 5, wherein the generating the written report is performed by another remote computer, apart from the remote computer operating the medical image software.

8. The process of claim 5, wherein the generating the written report comprises:
sending voice data to the remote computer;
returning a list of words matching the voice data; and
generating the written report by the thin client.

9. The process of claim 8, further comprising editing the written report through the thin client.

10. The process of claim 1, wherein the associating the written report with the medical images comprises providing a link to the images within the report.

11. The process of claim 1, wherein the associating the written report with the medical images comprises embedding the images within the report, wherein the generating the written report is performed by the remote computer.

12. The process of claim 1, further comprising editing the written report.

13. The process of claim 1, further comprising:
approving the written report by digitally signing the report; and
transmitting the report to another user for approval.

14. The process of claim 1, wherein the report further comprises at least one of: Clinical reports; Measurements and image notations;
and Reports from a computer aided diagnosis system.

15. A system for voice to text reporting for medical image software, comprising:
at least one user computer operating a thin client;
a first remote server operating medical image processing software, the remote sever comprising a medical image database;
a second remote server comprising a voice to text engine; and
a computer network connecting the user computer and the first and second remote servers;
wherein a user views medical images from the database via the thin client;
the user verbally dictates a report into the user computer creating a dictated report;
the dictated report is transmitted from the computer via the network to the second remote server;
the voice to text engine of the second server generates a written report from the dictated report; and
the first server is operative to associate the written report with the medical images and store the written report in the database with the medical images.

16. The system of claim 15, wherein the user computer comprises a tablet, a smart phone, a cellular telephone, or other portable electronic device.

17. The system of claim 15, wherein the thin client is a Web browser.

18. The system of claim 15, wherein the dictated report is transmitted simultaneously during dictation by the user.

19. The system of claim 15, wherein the dictated report is transmitted after dictation by the user is completed.

20. The system of claim 15, wherein the system further comprises a report approval mechanism, such that the user can electronically sign the written report and forward the report to another user for approval.

21. The system of claim 15, wherein the first and second servers are the same server.

22. The system of claim 15, wherein at least one of the first and second servers comprises a plurality of computers.
